(19) United States
(12) Patent Application Publication
(10) Pub. No.: US 2013/0128415 A1
(43) Pub. Date: May 23, 2013

(54) CAPACITOR

(71) Applicant: Takashi Suzuki, Fukushima (JP)

(72) Inventor: Takashi Suzuki, Fukushima (JP)

(73) Assignee: INNOVATION ENERGY, INC., Osaka (JP)

(21) Appl. No.: 13/703,510

(22) PCT Filed: Nov. 22, 2011
(86) PCT No.: PCT/JP2011/006503

§ 371 Date: Dec. 11, 2012

(51) Int. Cl. H01G 9/042

(52) U.S. Cl. CPC H01G 9/0425
USPC 361/508

(57) ABSTRACT

The purpose of the present invention is to provide a capacitor having a novel structure in which electric energy is stored by means of charge transfer between a polarizable electrode and a metallic compound, as well as an electric double layer formed at an interface between the polarizable electrode and an electrolytic solution. The capacitor of the present invention has: a positive electrode collector; a positive electrode active material layer containing carbon material, polylactide, and V³⁺ compound; a separator; a negative electrode active material layer containing carbon material, polylactide, and V⁴⁺ compound; a negative electrode collector; and an electrolytic solution that is impregnated into the positive active material layer, the separator, and the negative active material layer.

### TECHNICAL FIELD

The present invention relates to a capacitor. More specifically, the present invention relates to the capacitor comprising a positive electrode active material layer containing a V³⁺ compound, and a negative electrode active material layer containing a V⁴⁺ compound.

### BACKGROUND ART

An Electric double layer capacitor accumulates electric energy in an electric double layer formed at an interface between a polarizing electrode and an electrolyte solution. In comparison with a lithium ion secondary battery, a nickel metal hydride secondary battery or the like, the electric double layer capacitor has characteristics of superior input-output properties, life-time properties, and safety properties, since no chemical reaction is involved at the time of charging and discharging. Such electric double layer capacitor is capable of miniaturization and charging of a high capacity, and widely used for the purpose of backing up microcomputers, memories, timers or the like, and the purpose of assisting various types of power sources. In addition, making full use of their characteristics, electric double layer capacitors having more capacity have been developed in recent years.

The electric double layer capacitor suffers from the problem that it has more power density but less energy density in comparison with the secondary battery which generates electricity by chemical reaction. A redox-capacitive capacitor or a pseudo-capacitance capacitors based on charge transfer at interfaces of electrodes, a hybrid capacitor which is a combination of the above two type capacitors, ionic liquid capacitor in which ionic liquid is used as the electrolyte, and the like have been developed, in order to increase the energy density of the electric double layer capacitors. For example, PTL1 discloses an electric double layer capacitor having a negative electrode sheet onto the surface of which lithium is flame spray coated (see PTL1).

### CITATION LIST

### Patent Literature

PTL1: Japanese Patent Laid-open No. 2010-080858.

### SUMMARY OF INVENTION

### Technical Problem

The purpose of the present invention is to provide a capacitor of a novel structure, which stores electric energy by not only an electric double layer formed at an interface between an polarizable electrode and an electrolytic solution, but also charge transfer between the polarizable electrode and metallic compound.

### Solution to Problem

The capacitor of the present invention comprises: a positive electrode collector; a positive electrode active material layer comprising carbon material, polylactic acid and V³⁺ compound selected from the group consisting of V₂O₃, VF₃, VCl₃, V(acac)₃, and VSO₄OH; a separator; a negative electrode active material layer comprising carbon material, polylactic acid and V⁴⁺ compound selected from the group consisting of VOSO₄, VF₄, VCl₄, VO(acac)₂, and V(SO₄)₂; a negative electrode collector; and an electrolytic solution which is impregnated into the positive electrode active material layer, the separator, and the negative electrode active material layer.

The capacitor of the other embodiment of the present invention comprises a plurality of a first electrode laminates, one or more of a second electrode laminates, a plurality of separators, and an electrolytic solution, wherein: the first electrode laminate comprises a first collector and a first active material layer comprising carbon material, polylactic acid and one of V⁺ or V⁴⁺ compound; the second electrode laminate comprises a second collector and a second active material layer comprising carbon material, polylactic acid and the other of V³⁺ or V⁴⁺ compound; each of the separators is disposed between the first and second electrode laminates; and the electrolytic solution is impregnated into the first active material layer, the second active material layer, and the separator. Here, the first active material layer may comprise the V³⁺ compound, the first electrode laminate is a positive electrode collector, the second active material layer may comprise the V⁴⁺ compound, and the second electrode laminate is a negative electrode collector. Alternative, the first active material layer may comprise the V⁴⁺ compound, the first electrode laminate is a negative electrode collector, the second active material layer may comprise the V³⁺ compound, and the second electrode laminate is a positive electrode collector. Further, the plurality of the first electrode laminates may be electrically connected to each other, and the one or more of the second electrode laminates may be electrically connected to each other. Further, the carbon material in the first and second active material layer may comprise a mixture of activated carbon and carbon nanotubes or fullerene. The V³⁺ compound may be selected from the group consisting of V₂O₃, VF₃, VCl₃, V(acac)₃, and VSO₄OH. The V⁴⁺ compound may be selected from the group consisting of VOSO₄, VF₄, VCl₄, VO(acac)₂, and V(SO₄)₂.

### Advantageous Effects of Invention

The capacitor of the present invention has advantages of capability of rapid charging and low-cost production. Further, the capacitor of the present invention does not cause any problem even in an overcharged state, since generation of ignitable component or toxic gas, which is a problem in lithium-based secondary batteries, never occurs in the capacitor of the present invention. Further, no problem occurs in reuse of the capacitor of the present invention, even if the capacitor is over-discharged, differently from the lithium-based secondary batteries. In addition, the capacitor of the present invention can be stably supplied, since the capacitor of the present invention is made from inexpensive material and free from rare-metals or the like.

### BRIEF DESCRIPTION OF DRAWINGS

FIG. 1 is a schematic cross-sectional view of an example of the capacitor of the present invention;

FIG. 2A is a schematic cross-sectional view of the capacitor of an example of the other embodiment of the present invention;

FIG. 2B is a schematic cross-sectional view of an example of a top single-sided positive electrode laminate;

FIG. 2C is a schematic cross-sectional view of an example of a double-sided positive electrode laminate;

FIG. 2D is a schematic cross-sectional view of an example of a bottom single-sided negative electrode laminate; and

FIG. 2E is a schematic cross-sectional view of an example of a double-sided negative electrode laminate.

### DESCRIPTION OF EMBODIMENTS

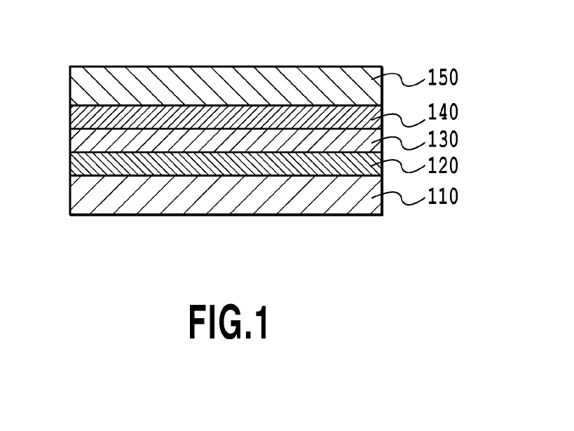

As shown in FIG. 1, the capacitor of the present invention comprises a positive electrode collector 110, a positive electrode active material layer 120, a separator 130, a negative electrode active material layer 140, a negative electrode collector 150, and an electrolytic solution that is impregnated into the first active material layer 120, the separator 130, and the second active material layer 140.

The negative electrode collector 150 in the present invention is made from metal, preferably copper. The negative electrode collector 150 is preferably made with a copper foil having a thickness of 40 to 50 μm, in order to facilitate shaping of the capacitor

The positive electrode collector 110 in the present invention is made from metal, preferably aluminum. Similarly to the negative electrode collector 150, the positive electrode collector 110 is preferably made with an aluminum foil having a thickness of 40 to 50 μm, in order to facilitate shaping of the capacitor. Further, it is preferable to roughen a surface of the positive electrode collector 110, the surface being in contact with the positive electrode active material layer 120. The roughness of the surface of the positive electrode collector 110 provide anchoring effect of fixing nanocarbon in the positive electrode active material layer 120, which can be dissociated from the positive electrode collector 110 during the step of shaping the capacitor. In the present invention, it is preferable to subject the surface of the positive electrode collector 110 to a roughening treatment referred to as “A20” processing, to increase the actual surface area to 20 times of the apparent surface area.

The separator 130 of the present invention is a structural element which prevents from a short circuit of the capacitor by maintaining the positive electrode active material layer 120 and the negative electrode active material layer 140 in a non-contact state, and facilitates transfer of ions in the electrolytic solution between the positive electrode active material layer 120 and the negative electrode active material layer 140. The separator 130 may be an insulating paper made from wood pulp, glass fiber, polyolefin-based fiber, fluorine-based fiber, polyimide-based fiber, aramid fiber, or the like. Alternatively, an insulating paper made from polylactide fiber can be used as the separator 130. More preferably, the separator 130 may be an insulating paper made from glass fiber or polylactide fiber. The separator 130 may have a thickness of 8 to 100 μm and a porosity of 30 to 95%, in order to achieve the above-described functions.

The positive electrode active material layer 120 of the present invention is a porous layer which comprises carbon material, polylactide, and V³⁺ compound, and is capable of being impregnated with the electrolytic solution.

The carbon material of the present invention is a mixture of nanocarbons having a size of the order of nanometers, and carbonous or graphite material having a size of the order of micrometers. The nanocarbons include commercially available carbon nanotubes and fullerenes. Desirably, the carbonous or graphite material is material having an average particle size of 2 to 6 μm and comprising pores of a size of the order of nanometers. Preferable carbonous or graphite material includes activated carbon.

The polylactide in the positive electrode active material layer functions as a binder for binding the nanocarbons and the carbonous or graphite material. Further, the polylactide also functions as a binder for binding the carbon material bound by the polylactide as described above and the positive electrode collector. In the present invention, the polylactide has a number average molecular weight of 30,000 to 100,000.

The V³⁺ compound in the positive electrode active material layer 120 is a salt of trivalent vanadium. In the present invention, the V³⁺ compound is selected from the group consisting of V₂O₃, VF₃, VCl₃, V(acac)₃ (wherein “acac” represents acetylacetonate) and VSO₄OH. The V³⁺ compound contributes to achieving a function of storing electric charge to increase capacitance of the capacitor, by the mechanism that the center metal V³⁺ releases one electron to form V⁴⁺ during charging, and such formed V⁴⁺ accepts one electron to form V³⁺ during discharging.

The positive electrode active material layer 120 comprises 20 to 65 parts by weight of the polylactide and 1 to 3 parts by weight of the V³⁺ compound, per 100 parts by weight of the carbon material. On the other hand, the carbon material comprises 1 to 50% by weight of the nanocarbons and 50 to 99% by weight of the carbonous or graphite material, based on the total weight of the carbon material. Preferably, the carbon material comprises 1 to 5% by weight of the nanocarbons and 95 to 99% by weight of the carbonous or graphite material, based on the total weight of the carbon material.

The positive electrode composition is formed by adding the carbon material into the polylactide which is softened or melted by heating in the absence of solvent and kneading them, and then adding the V³⁺ compound and kneading them. It is preferable to carry out the kneading step under reduced pressure, in order to prevent from trapping bubbles in the composition. Subsequently, the positive electrode active material layer can be formed by applying the positive electrode composition onto one or both surfaces of the positive electrode collector 110. Any means known in the art such as gravure coating, doctor blade coating, roll coating can be used in the application of the composition onto the positive electrode collector 110. The positive electrode active material layer 120 of the present invention preferably has a thickness of 100 to 200 μm. Alternatively, self-supporting positive electrode active material layer 120 can be formed by applying the positive electrode composition onto a temporary substrate followed by peeling the resultant coated film from the temporary substrate.

The negative electrode active material layer 140 of the present invention is a porous layer which comprises carbon material, polylactide, and V⁴⁺ compound, and is capable of being impregnated with the electrolytic solution. The carbon material and polylactide useful in the negative electrode active material layer 140 are the same as those in the positive electrode active material layer.

The V⁴⁺ compound in the negative electrode active material layer 140 is a salt of tetravalent vanadium. In the present invention, the V⁴⁺ compound is selected from the group consisting of V₂O₄, VOSO₄, VF₄, VCl₄, VO(acac)₂, and V(SO₄)₂. The V⁴⁺ compound contributes to achieving a function of storing electric charge to increase capacitance of the capacitor, by the mechanism that the center metal V⁴⁺ accepts one electron to form V³⁺ during charging, and such formed V³⁺ releases one electron to form V⁴⁺ during discharging.

The negative electrode active material layer 140 comprises 20 to 65 parts by weight of the polylactide and 1 to 3 parts by weight of the V³⁺ compound, per 100 parts by weight of the carbon material. On the other hand, the ratio between the nanocarbons and the carbonous or graphite material in the carbon material is similar to that in the positive electrode active material layer 120.

The negative electrode active material layer 140 can be formed by the similar procedure to that for the positive electrode active material layer 120. The negative electrode active material layer of the present invention has a thickness of 100 to 200 μm.

The electrolytic solution is an organic solution comprising an electrolyte and organic solvent. The electrolyte comprise a cationic component such as quaternary ammonium salt, imidazolium salt or pyridinium salt, and an anionic component such as BF₄⁻, PF₆⁻, CF₃SO₃⁻, or (CF₃SO₂)N⁻. The electrolyte of the present invention is preferably a BF₄⁻ salt of quaternary ammonium, more preferably (C₂H₅)₃(CH₃)NBF₄. The electrolyte of the present invention is present in a range of 1 to 1.5 mole percent in the electrolytic solution. The organic solvent used in the electrolytic solution of the present invention includes polar aprotic solvent such as propylene carbonate, sulfolane, ethylene carbonate, γ-butyrolactone, N,N-dimethylformamide, or dimethylsulfoxide. Mixtures of the above-described solvent can be used as the organic solvent of the present invention. Preferably, the organic solvent is a mixture of propylene carbonate and sulfolane.

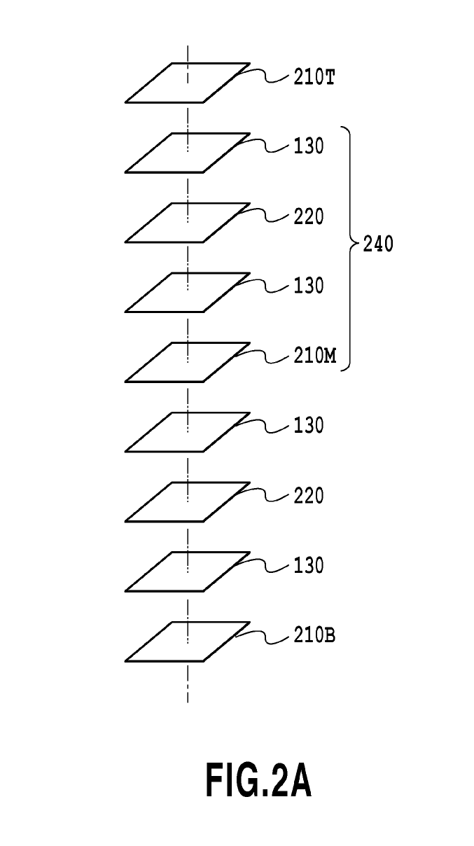

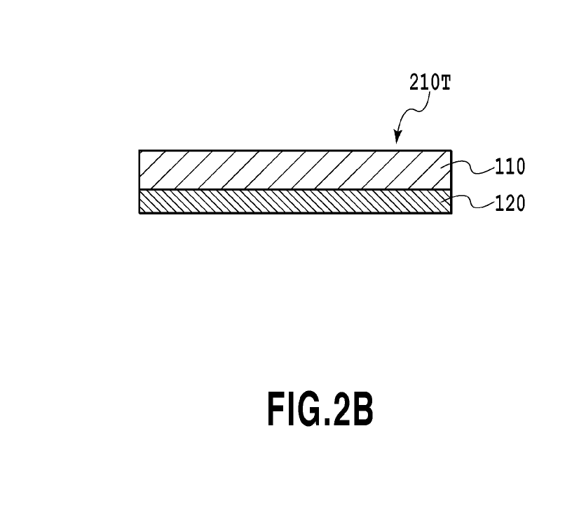

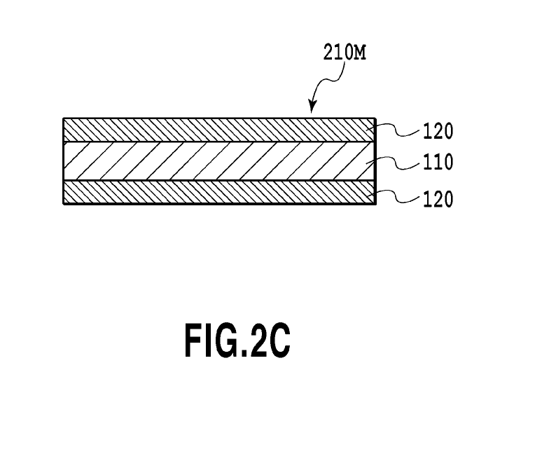

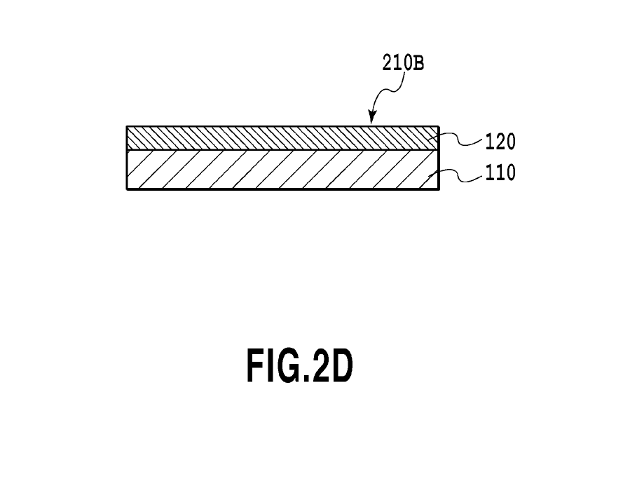

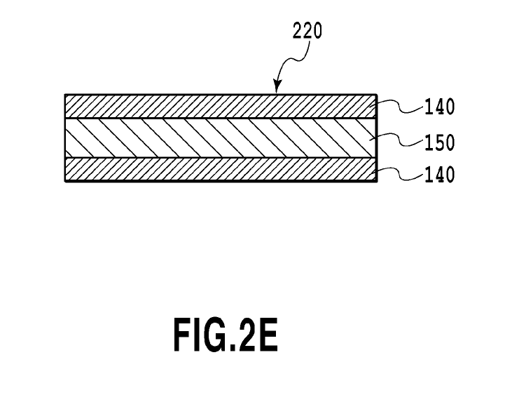

The capacitor of the other embodiment of the present invention comprises a plurality of a first electrode laminates, one or more of second electrode laminates, a plurality of separators, and an electrolytic solution, wherein: the first electrode laminate comprises a first collector and a first active material layer comprising carbon material, polylactic acid and one of V³⁺ or V⁴⁺ compound; the second electrode laminate comprises a second collector and a second active material layer comprising carbon material, polylactic acid and the other of V³⁺ or V⁴⁺ compound; each of the separators is disposed between the first and second electrode laminates; and the electrolytic solution is impregnated into the first active material layer, the second active material layer, and the separator. A constitutional example, where the first electrode laminate is a positive electrode collector and the second electrode laminate is a negative electrode collector, is shown in FIGS. 2A to 2E. In the constitution shown in FIGS. 2A to 2E, separator 130, double-sided negative electrode laminate 220 in which negative electrode active material layers 140 are provided on the both surfaces of negative electrode collector 150, and separator 130 are disposed between top single-sided positive electrode laminate 210T and bottom single-sided positive electrode laminate 210B, wherein both of the top single-sided positive electrode laminate 210T and bottom single-sided positive electrode laminate 210B comprise a positive electrode active material layer 120 provided on one surface of positive electrode collector 110, and wherein the electrolytic solutions is impregnated into the positive electrode active material layer 120, the negative electrode active material layer 140, and the separator 130. In this constitution, more of internal capacitors can be formed by further laminating additional structure 240 consisting of double-sided positive electrode laminate 210M in which positive electrode active material layers 120 are provided on the both surfaces of positive electrode collector 110, separator 130, the double-sided negative electrode laminate 220 and separator 130. If necessary, a plurality of additional structures 240 can be laminated.

FIG. 2A shows a constitution in which a plurality of internal capacitors are connected in series. However, laminated capacitor, in which a plurality of internal capacitors are parallelly connected can be formed, by electrically connecting the top single-sided positive electrode laminate 210T, the one or more double-sided positive electrode laminate 210M, and the bottom single-sided positive electrode laminate 210B to each other, and electrically connecting the one or more double-sided negative electrode laminate 220 to each other. Further, FIG. 2A shows an example in which the positive electrode laminate is disposed at the top and bottom of the capacitor. However, alternative constitution, where the negative electrode laminate is disposed at the top and bottom of the capacitor, is also adoptable.

The first step of production of the capacitor of the present invention is: to laminate a positive electrode laminate in which the positive electrode active material layers 120 are provided on the both surfaces of the positive electrode collector 120, separator 130, a negative electrode laminate in which the positive electrode active material layers 140 are provided on the both surfaces of the negative electrode collector 140, and separator 130 in this order; to apply a pressure to the resultant laminate for integrating these layers; and to wind it up into a rolled shape. Then, the intermediate of the rolled shape is compression molded into a desired shape, an approximately rectangular parallelepiped shape for example. Subsequently, the electrolytic solution is impregnated into the positive electrode active material layer, the negative electrode active material layer, and the separator in the intermediate. The capacitor of the present invention can be obtained by carrying out further processing such as attaching terminals for external connection and wrapping with an insulative seal material. The insulative seal material may include any material known in the art, as long as it can prevent leakage of the electrolytic solution and electrical connection between inside and outside of the capacitor.

A method for producing the capacitor of the other embodiment of the present invention comprises: laminating respective constituting layers (the separator 130, the double-sided negative electrode laminate 220, and the separator 130 between the top single-sided positive electrode laminate 210T and the bottom single-sided positive electrode laminate 210B); and impregnating the electrolytic solution into the positive electrode active material layers 120, the negative electrode active material layers 140, and the separators 130. In this method, a desired number of the additional structures 240 may further laminated in the first step.

The above description explains the case where the positive electrode active material layer 120 and negative electrode active material layer 140 are formed on the positive electrode collector 110 and negative electrode collector 150, respectively. Alternatively, the positive electrode active material layer 120 and negative electrode active material layer 140, which are self-supporting, can be used to form the capacitor of the present invention. In this case, the capacitor of the present invention can be formed by similar method to that described above, except that the positive electrode active material layer 120, the positive electrode collector 110, the positive electrode active material layer 120, the separator 130, the negative electrode active material layer 140, the negative electrode collector 150, the negative electrode active material layer 140, and the separator 130 are laminated in this order.

Further, the capacitor obtained as above can be subjected to processing such as cutting, cutting off, folding, perforating, molding.

### EXAMPLES

### Example 1

Polylactide (3.572 g) having a number average molecular weight of 32,000 was heated to 200° C. under reduced pressure to melt. To the molten polylactide was added carbon nanotube (0.64 g) and activated carbon (5 g) having an average particle diameter of 1 μm and kneaded. Then, VSO₄OH (0.188 g) was added and kneaded to obtain a positive electrode composition. The positive electrode composition was coated onto the both surfaces of an aluminum foil having a thickness of 40 μm which had been subjected to “A20” treatment by roll coating, to form a positive electrode laminate wherein the positive electrode active material layers having a thickness of 150 μm were formed on the both surfaces of the aluminum foil (a positive electrode collector).

Polylactide (3.572 g) having a number average molecular weight of 32,000 was heated to 200° C. under reduced pressure to melt. To the molten polylactide was added carbon nanotube (0.64 g) and activated carbon (4 g) having an average particle diameter of 1 μm and kneaded. Then, V(SO₄)₂ (0.188 g) was added and kneaded to obtain a negative electrode composition. The negative electrode composition was coated onto the both surfaces of a copper foil having a thickness of 40 μm by roll coating, to form a negative electrode laminate wherein the negative electrode active material layers having a thickness of 150 μm were formed on the both surfaces of the copper foil (a negative electrode collector).

Triethylmethylammonium tetrafluoroborate was dissolved in a mixture of sulfolane and propylene carbonate in a ratio of 1:2.8 to form an electrolytic solution. The concentration of triethylmethylammonium tetrafluoroborate was 1.5 mole percent.

The positive electrode laminate, a separator (pulp separator manufactured by Nippon Kodoshi Corporation), the negative electrode laminate, and a separator are laminated in this order and passed through a pair of press rolls to integrate these constituting layers, and then wound into a rolled shape. Then, the intermediate of the rolled shape was placed in a mold and pressed into an approximately rectangular parallelepiped shape. Subsequently, the electrolytic solution was impregnated into the positive electrode active material layers, the negative electrode active material layers, and the separators in the intermediate. After that, attachment of the terminals for external connection and wrapping with an insulative seal material was carried out to obtain a capacitor.

The resultant capacitor had a mass of 22.9 g, an equivalent series resistance (ESR) of 400 mΩ, a residual voltage of 10 mV, and a capacitance of 640 F. Further, a current of 3.7 V and 1 A can be taken out of the resultant capacitor.

### Example 2

Polylactide (3.572 g) having a number average molecular weight of 32,000 was heated to 200° C. under reduced pressure to melt. To the molten polylactide was added carbon nanotube (0.64 g) and activated carbon (5 g) having an average particle diameter of 1 μm and kneaded. Then, VSO₄OH (0.188 g) was added and kneaded to obtain a positive electrode composition. A positive electrode collector 110 was formed from an aluminum foil having a thickness of 30 μm which had been subjected to “A20” treatment. The positive electrode collector 110 was constituted of an electrode part having a long side of a length of 5.9 cm and a short side of a length of 3.9 cm, and a tab for external connection disposed on the short side of the electrode part and having a dimension of 1.5 cm by 0.5 cm. The positive electrode composition was coated onto a single surface of the electrode part of the positive electrode collector 110 by roll coating, to form top and bottom single-sided positive electrode laminates 210T and 210B on which a positive electrode active material layer 120 having a thickness of 80 μm was formed. Further, the positive electrode composition was coated onto both surfaces of the electrode part of the positive electrode collector 110 by roll coating, to form a double-sided positive electrode laminates 210M, on each surface of which a positive electrode active material layer 120 having a thickness of 80 μm was formed.

Polylactide (3.572 g) having a number average molecular weight of 32,000 was heated to 200° C. under reduced pressure to melt. To the molten polylactide was added carbon nanotube (0.64 g) and activated carbon (4 g) having an average particle diameter of 1 μm and kneaded. Then, V(SO₄)₂ (0.188 g) was added and kneaded to obtain a negative electrode composition.

A negative electrode collector is formed from a copper foil having a thickness of 30 μm. Similarly to the positive electrode collector 110, the negative electrode collector 150 was constituted of an electrode part having a long side of a length of 5.9 cm and a short side of a length of 3.9 cm, and a tab for external connection disposed on the short side of the electrode part and having a dimension of 1.5 cm by 0.5 cm. The negative electrode composition was coated onto both surfaces of the electrode part of the negative electrode collector 150 by roll coating, to form a double-sided negative electrode laminates 220, on each surface of which a negative electrode active material layer 140 having a thickness of 60 μm was formed.

Triethylmethylammonium tetrafluoroborate was dissolved in a mixture of sulfolane and propylene carbonate in a ratio of 1:2.8 to form an electrolytic solution. The concentration of triethylmethylammonium tetrafluoroborate was 2.5 mole percent.

Separator 130 (pulp separator manufactured by Nippon Kodoshi Corporation, having a long side of a length of 6 cm, a short side of a length of 4 cm, and a thickness of 20 μm), the double-sided negative electrode laminate 220, the separator 130, and the double-sided positive electrode laminate 210M were laminated in this order, onto the positive electrode active material layer 120 of the bottom single-sided positive electrode laminate 210B. This lamination was repeated for sixteen times. Further, onto the double-sided positive electrode laminate at the top of the laminate, the separator 130, the double-sided negative electrode laminate 220, the separator 130, and the top single-sided positive electrode laminate 210T were laminated. Here, the positive electrode active material layer 120 of the top single-sided positive electrode laminate 210T was in contact with the separator 130. In the above lamination, the tabs for external connection of the positive electrode laminates (210B, 210M and 210T) were disposed on a single straight line extending to the laminating direction, and the tabs for external connection of the negative electrode laminates (220) were disposed on the other straight line extending to the laminating direction, such that the tabs for external connection of the positive electrode laminates (210B, 210M and 210T) kept form overlapping with the tabs for external connection of the negative electrode laminates (220), in view of the laminating direction. The resultant laminate had eighteen positive electrode laminates (210B, 210M, and 210T) and seventeen negative electrode laminates (220). The resultant laminate had a structure wherein the adjacent positive electrode laminate (210B, 210M, or 210T) and negative electrode laminate (220) was separated by the separator.

Subsequently, the resultant laminate was passed through a pair of press rolls to integrate the constituting layers. Then, the electrolytic solution was impregnated into the separators, the positive electrode active material layers 120, and the negative electrode active material layers 140. After that, the tabs for external connection of all of the positive electrode laminates (210B, 210M and 210T) were connected to externally connecting positive electrode terminal, and the tabs for external connection of all of the negative electrode laminates (220) were connected to externally connecting negative electrode terminal, such that internal capacitors, which were constituted of a pair of the positive electrode laminate (210B, 210M and 210T) and the negative electrode laminate (220), were connected parallelly. Subsequently, the laminate was wrapped with an insulative seal material to obtain a capacitor having an approximately rectangular parallelepiped shape having a long side of a length of 6.2 cm, a short side of a length of 4.0 cm, and a height of 7.0 mm (except for connecting terminals). The resultant capacitor had a mass of 42.0 g, an equivalent series resistance (ESR) of 25 mΩ, and a service capacity of 2000 mAh. Further, a current of 3.7 V and 2 A can be taken out of the resultant capacitor.

A durability test for charging and discharging of the resultant capacitor was carried out in accordance with the following procedure. A single cycle of charging and discharging consists of charging at a constant current of 2 A for 1 minutes (1 C), an idle period for 10 seconds, and discharging at a constant current of 2 A for 1 minutes (1 C). Charging and discharging was carried out with a charging and discharging cycle checker manufactured by DENSHI HYOGEN COMPANY, which was made for this test, and with intervals between the cycles of 10 seconds. At every hundred cycles of charging and discharging, the capacitor was fully charged with LiPo8 expert charger (manufactured by ABC Hobby Co., Ltd.) under the conditions of a constant voltage of 4.1 V and a constant current of 2 A. Subsequently, the service capacity was measured when carrying out discharging at a constant current of 2 A (discharge cut-off voltage of 3.3 V) with LiPo8 expert charger. Table 1 shows the relationship between the number of cycles of charging and discharging and the service capacity.

TABLE 1

| The number of charging and | Service capacity |
|---|---|
| discharging | (mAh) |
| 0 | 2000 |
| 100 | 1856 |
| 200 | 1875 |
| 300 | 1850 |
| 400 | 1839 |
| 500 | 1866 |
| 600 | 1895 |
| 700 | 1807 |
| 800 | 1840 |
| 900 | 1874 |
| 1000 | 1872 |
| 1100 | 1820 |
| 1200 | 1853 |
| 1300 | 1852 |
| 1400 | 1754 |
| 1500 | 1801 |
| 1600 | 1814 |
| 1700 | 1859 |
| 1800 | 1826 |

From the above results, it can be seen that the capacitor of the present invention has a service capacity of about 92% of the initial service capacity, even after repeated 1800 cycles of charging and discharging. It is seen that the capacitor of the present invention has a high durability for charging and discharging. Further, the above results obtained even though this test was carried out under severe conditions of a low temperature of 10-17° C. Taking the characteristics of this capacitor into account, it is expected that better result would be obtained under the conditions of higher temperature.

### REFERENCE SIGNS LIST

110 Positive electrode collector
120 Positive electrode active material layer
130 Separator
140 Negative electrode active material layer
110 Negative electrode collector
210T Top single-sided positive electrode laminate
210B Bottom single-sided positive electrode laminate
210M Double-sided positive electrode laminate
220 Double-sided negative electrode laminate
240 Additional structure

1. A capacitor comprising:
a positive electrode collector;
a positive electrode active material layer comprising carbon material, polylactide, and V³⁺ compound;
a separator;
a negative electrode active material layer comprising carbon material, polylactide, and V⁴⁺ compound;
a negative electrode collector; and
an electrolytic solution that is impregnated into the first active material layer, the separator, and the second active material layer.

2. The capacitor according to claim 1, wherein the carbon material in the positive and negative electrode active material layer is a mixture of activated carbon, and carbon nanotubes or fullerenes.

3. The capacitor according to claim 1, wherein the V³⁺ compound is selected from the group consisting of V₂O₃, VF₃, VCl₃, V(acac)₃ and VSO₄OH.

4. The capacitor according to claim 1, wherein the V⁴⁺ compound is selected from the group consisting of V₂O₄, VOSO₄, VF₄, VCl₄, VO(acac)₂, and V(SO₄)₂.

5. A capacitor comprising a plurality of a first electrode laminates, one or more of second electrode laminates, a plurality of separators, and an electrolytic solution, wherein:
the first electrode laminate comprises a first collector and a first active material layer comprising carbon material, polylactic acid and one of V³⁺ or V⁴⁺ compound;
the second electrode laminate comprises a second collector and a second active material layer comprising carbon material, polylactic acid and the other of V³⁺ or V⁴⁺ compound;
each of the separators is disposed between the first and second electrode laminates; and
the electrolytic solution is impregnated into the first active material layer, the second active material layer, and the separator.

6. The capacitor according to claim 5, wherein the first active material layer comprises V³⁺ compound, the first electrode laminate is a positive electrode collector, the second active material layer comprises V⁴⁺ compound, and the second electrode laminate is a negative electrode collector.

7. The capacitor according to claim 5, wherein the first active material layer comprises V⁴⁺ compound, and the first electrode laminate is a negative electrode collector, the second active material layer comprises V³⁺ compound, and the second electrode laminate is a positive electrode collector.

8. The capacitor according to claim 5, wherein the plurality of first electrode laminates are electrically connected to each other, and the one or more of second electrode laminates are electrically connected to each other.

9. The capacitor according to claim 5, wherein the carbon material in the positive and negative electrode active material layer is a mixture of activated carbon, and carbon nanotubes or fullerenes.

10. The capacitor according to claim 5, wherein the V³⁺ compound is selected from the group consisting of V₂O₃, VF₃, VCl₃, V(acac)₃ and VSO₄OH.

11. The capacitor according to claim 5, wherein the V⁴⁺ compound is selected from the group consisting of V₂O₄, VOSO₄, VF₄, VCl₄, VO(acac)₂, and V(SO₄)₂.
